(19) United States
(12) Patent Application Publication
(10) Pub. No.: US 2004/0001107 A1
(43) Pub. Date: Jan. 1, 2004

(54) Image management system and method

(76) Inventor: Virgil Kay Russon, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/185,179

(22) Filed: Jun. 27, 2002

(51) Int. Cl. G09G 5/00

(52) U.S. Cl. 345/838; 345/802

(57) ABSTRACT

An image management system comprises a management application accessible by a processor and adapted to monitor access to a plurality of image files. The system also comprises an interface adapted to chronologically display a plurality of thumbnail images corresponding to the access of the corresponding image files.

### TECHNICAL FIELD OF THE INVENTION

The present invention relates generally to the field of computer systems and, more particularly, to an image management system and method.

### BACKGROUND OF THE INVENTION

With the advance of computer technology, images are increasingly used in a variety of computer applications. For example, software applications such as image editors or image managers may be used to modify, manipulate or otherwise operate on image files. Additionally, images are often included in web pages, attached to electronic mail messages, or included in documents or other types of presentation materials. Accordingly, libraries of image files are oftentimes stored on a computer system to accommodate the use, transfer, or other manipulation of the images.

Locating and using the images stored on the computer system, however, may be difficult and time-consuming. For example, as the quantity of image files stored on the computer system increases, locating the desired image file may require opening many image files until the desired image file is located. Alternatively, image files may be stored to the computer system using nomenclature identifying the particular image file to a user of the computer system. However, similar images are often stored having similar nomenclatures. Accordingly, locating a desired image file is generally an exercise in memory recall, thereby generally resulting in trial-and-error image file searching.

### SUMMARY OF THE INVENTION

In accordance with one embodiment of the present invention, an image management system comprises a management application accessible by a processor and adapted to monitor access to a plurality of image files. The system also comprises an interface adapted to chronologically display a plurality of thumbnail images corresponding to the access of the corresponding image files.

In accordance with another embodiment of the present invention, an image management method comprises monitoring a plurality of requests each relating to an access of a corresponding image file. The method also comprises chronologically displaying on an interface a plurality of thumbnail images corresponding to the access of the image files.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of an image management system in accordance with the present invention;

FIG. 2 is a diagram illustrating an embodiment of an image management system in accordance with the present invention; and

FIG. 3 is a flow chart illustrating an embodiment of an image management method in accordance with the present invention.

### DETAILED DESCRIPTION OF THE DRAWINGS

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of an image management system 10 in accordance with the present invention. Briefly, system 10 automatically generates a display of recently-accessed images to enable quick and easy identification and selection of images by a user of system 10. For example, system 10 dynamically monitors access to image files to manage and chronologically display thumbnail images corresponding to recently-accessed images such that a user of system 10 may easily locate and identify desired images. System 10 automatically updates the displayed thumbnail images such that the most-recently-accessed images are displayed at a predetermined location within a display interface. The thumbnail display interface may be displayed in connection with an image editor or may be displayed independently of image-related software applications.

In the illustrated embodiment, system 10 comprises an input device 12, an output device 14, a processor 16, and a memory 18. Input device 12 may comprise a keyboard, key pad, pointing device, such as a mouse or a track pad, a scanner, an image-collection device, such as a digital camera, or other type of device for inputting information into system 10. Output device 14 may comprise a monitor, display, printer, or other type of device for generating an output.

The present invention also encompasses computer software that may be executed by processor 16. In the illustrated embodiment, system 10 comprises a management application 20, an editor application 22, and a thumbnail interface 24, which are computer software programs. However, it should be understood that system 10 may be implemented using software, hardware, or a combination of software and hardware. In the embodiment of FIG. 1, management application 20, editor application 22, and thumbnail interface 24 are illustrated as being stored in memory 18, where they may be executed by processor 16. However, management application 20, editor application 22, and thumbnail interface 24 may be otherwise stored as to be accessible by processor 16.

In the illustrated embodiment, system 10 also comprises a database 30 stored in memory 18. Database 30 comprises image information associated with images accessed by a user of system 10 and/or stored in system 10. For example, in the illustrated embodiment, database 30 has image files 32, which comprise image information associated with the images stored in system 10. Image files 32 may be input to database 30 using input device 12 or may be otherwise received or retrieved by system 10 and stored in database 30.

In operation, management application 20 dynamically monitors access relative to image files 32 and generates and/or manages thumbnail images corresponding to each image file 32 in response to access of a corresponding image file 32. As used herein, “access” of an image file 32 may comprise attaching a copy of image file 32 to an electronic mail message, requesting a printed copy of image file 32, inserting a copy of image file 32 into a document, uploading a copy of image file 32 to a web page, opening image file 32, importing or retrieving image file 32, modifying image file 32, or other actions or operations corresponding to a particular image file 32 whether or not a particular image file 32 is opened.

Thumbnail interface 24 generates a display for the thumbnail images generated and/or managed by management application 20 such that a user of system 10 may view the thumbnail images. In this embodiment, thumbnail interface 24 also chronologically organizes the thumbnail images corresponding to the accessing of a particular image. For example, in response to accessing an image, management application 20 determines whether a thumbnail image corresponding to the accessed image already resides on the interface display. If the thumbnail image already resides on the display interface, interface 24 relocates the thumbnail image to a beginning of the display corresponding to the most-recently-accessed image location. If the thumbnail image does not already reside on the interface display, management application 20 generates the thumbnail image corresponding to the image file 32. Accordingly, interface 24 then displays the thumbnail image on the display interface at the beginning of the display corresponding to the most-recently-accessed image. Thus, interface 24 dynamically organizes and displays the thumbnail images corresponding to the access of the corresponding image file.

As illustrated in FIG. 1, system 10 may also comprise editor application 22 for editing or otherwise manipulating image files 32. For example, image files 32 may be rotated, cropped, or otherwise manipulated using editor application 22. Image files 32 may also be copied or attached to electronic mail messages using editor application 22. However, as described above, management application 20 and the interface of displayed thumbnail images may be used in cooperation with editor application 22 or may be used independently of editor application 22 such that the thumbnail images may be displayed, viewed, selected or otherwise accessed by a user of system 10 in connection with a variety of independent software applications.

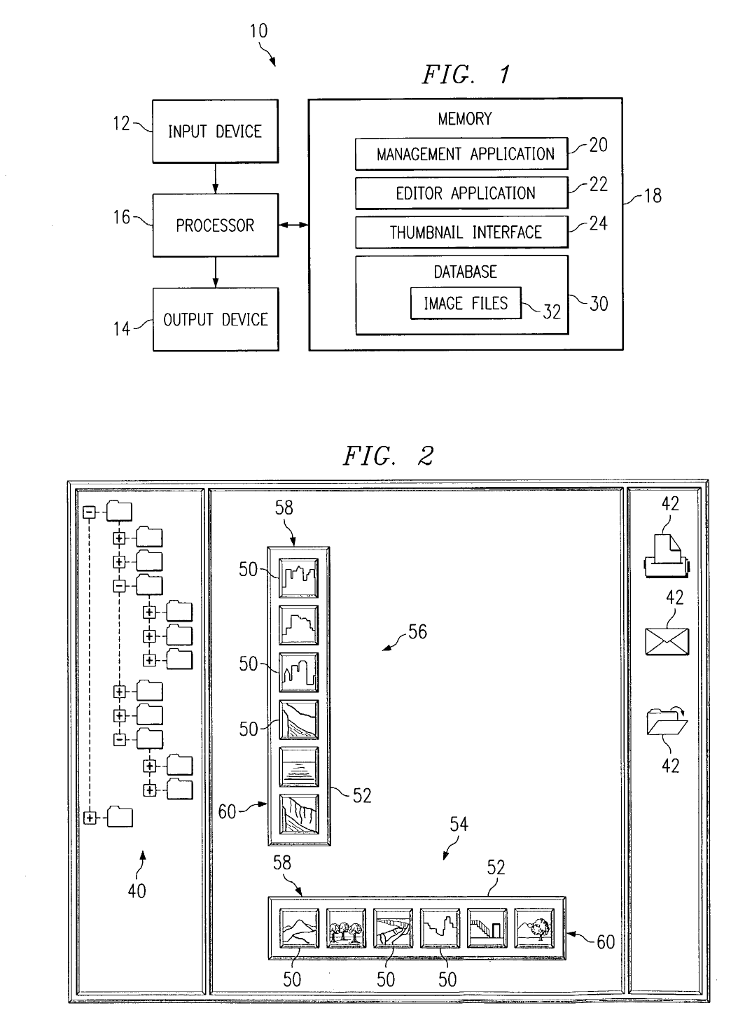

FIG. 2 is a diagram illustrating an embodiment of system 10 in accordance with the present invention. In FIG. 2, system 10 is illustrated in connection with editor application 22. For example, editor application 22 may comprise a file listing tree 40 indicating various storage locations for image files 32. Editor application 22 may also comprise a plurality of icons 42 each designating a particular action that may be performed corresponding to image files 32.

As illustrated in FIG. 2, a plurality of thumbnail images 50 each corresponding to one of image files 32 is illustrated via a thumbnail interface display 52. It will be appreciated that display 52 may be horizontally configured, as illustrated at 54, or may be vertically illustrated, as illustrated at 56; however, display 52 may be otherwise positioned and/or oriented.

In operation, as a particular image file 32 is accessed, management application 20 generates thumbnail image 50 corresponding to the accessed image file 32. The generated thumbnail image 50 is then added to display 52 by interface 24. Additionally, management application 20 may be adapted to determine whether the particular thumbnail image 50 corresponding to accessed image file 32 already resides on display 52. If the particular image 50 already resides on display 52, additional generation of thumbnail image 50 may not be required.

In the illustrated embodiment, images 50 are chronologically organized within display 52 such that the most-recently-accessed image files 32 are reflected at a predetermined location within display 52. For example, as illustrated in FIG. 2, system 10 may be adapted such that most-recently-accessed image files 32 are represented by thumbnail images 50 at a beginning 58 of display 52 and later-accessed image files 32 are represented by thumbnail images 50 in decreasing order toward an end 60 of display 52.

System 10 may also be adapted to display a predetermined quantity of thumbnail images 50. For example, system 10 may be adapted to automatically display a default quantity of thumbnail images 50 within display 52 or may be adapted to receive a value via input device 12 from a user of system 10 identifying the predetermined quantity of thumbnail images 50 to be displayed via display 52. Accordingly, as a quantity of thumbnail images 50 in display 52 increases, images 50 located near end 60 of display 52 may be deleted by interface 24 to provide for additional thumbnail images 50 at beginning 58 of display 52.

Management application 20 may also be adapted to determine whether a thumbnail image 50 corresponding to a particular image file 32 already resides on display 52. If a thumbnail image 50 corresponding to a particular image file 32 already resides on display 52, interface 24 may be adapted to relocate the particular thumbnail image 50 to beginning 58 of display 52 to reflect the most recent access of the corresponding image file 32. Additionally, as the quantity of thumbnail images 50 increases, a scroll bar or other feature associated with display 52 may be generated by interface 24 to accommodate advanced searching of display 52.

As described above, image files 32 may be located and/or selected from tree 40 to perform a particular operation on the image file 32. Additionally, images 50 may also be selected from display 52 by a user of system 10 to perform an action corresponding to a particular image file 32. For example, in operation, each thumbnail image 50 is linked to a corresponding image file 32 such that, for example, a particular image 50 may be dragged from display 52 and dropped on a particular icon 42 to perform a desired activity corresponding to a particular image file 32. Thus, selecting a particular thumbnail image 50 from display 52 thereby results in accessing a particular image file 32, thereby also requiring interface 24 to relocate the selected thumbnail image 50 to beginning 58 of display 52.

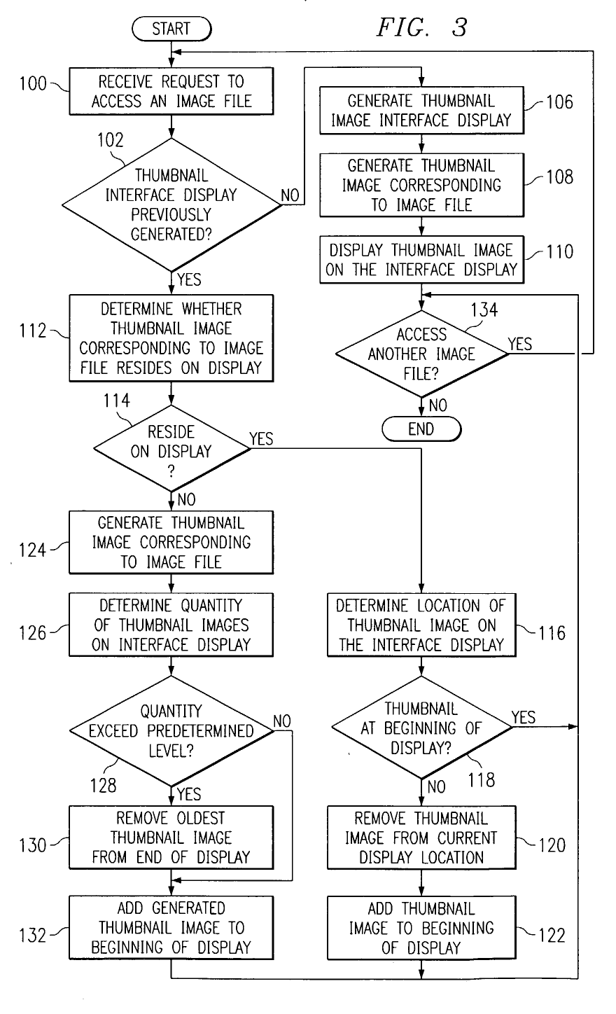

FIG. 3 is a flowchart illustrating an embodiment of a method for image management in accordance with the present invention. The method begins at step 100, where system 10 receives a request to access a particular image file 32. At decisional step 102, in response to accessing a particular image file 32, management application 20 automatically determines whether thumbnail image 50 interface display 52 has been previously generated. If display 52 has not been previously generated, the method proceeds to step 106, where interface 24 generates display 52. At step 108, management application 20 generates a thumbnail image 50 corresponding to the accessed image file 32. At step 110, interface 24 displays the generated thumbnail image 50 on display 52.

At step 102, if display 52 has been previously generated by interface 24, the method proceeds from step 102 to step 112, where management application 20 automatically determines whether a thumbnail image 50 corresponding to the accessed image file 32 already resides on display 52. At decisional step 114, if thumbnail image 50 corresponding to the accessed image file 32 resides on display 52, the method proceeds to step 116, where interface 24 determines a location of the thumbnail image 50 on display 52. At decisional step 118, interface 24 determines whether the thumbnail image 50 is located at beginning 58 of display 52. If the thumbnail image 50 is located at beginning 58 of display 52, the method proceeds from step 118 to step 134. If the thumbnail image 50 is not located at beginning 58 of display 52, the method proceeds from step 118 to step 120, where interface 24 removes the thumbnail image 50 from the current display 52 location. At step 122, interface 24 adds the thumbnail image 50 to beginning 58 of display 52. The method then proceeds to step 134.

At step 114, if a thumbnail image 50 corresponding to the accessed image file 32 does not reside on display 52, the method proceeds from step 114 to step 124, where management application 20 generates a thumbnail image 50 corresponding to the accessed image file 32. At step 126, interface 24 determines a quantity of thumbnail images 50 residing on display 52. At decisional step 128, interface 24 determines whether the quantity of thumbnail images 50 residing on display 52 exceeds a predetermined quantity or level. If the quantity of thumbnail images 50 residing on display 52 exceeds a predetermined quantity, the method proceeds from step 128 to step 130, where interface 24 removes the thumbnail image 50 from end 60 of display 52 representing the later-accessed image file 32. At decisional step 128, if the quantity of thumbnail images 50 does not exceed a predetermined quantity, the method proceeds from step 128 to step 132, where interface 24 adds the generated thumbnail image 50 to beginning 58 of display 52.

The method then proceeds to decisional step 134, where system 10 determines whether another requested access of an image file 32 is requested. If another requested access of an image file 32 is requested, the method returns to step 100. If another access of an image file 32 is not requested, the method ends.

It should be understood that in the described method, certain steps may be omitted, accomplished in a sequence different from that depicted in FIG. 3, or performed simultaneously. Also, it should be understood that the method depicted in FIG. 3 may be altered to encompass any of the other features or aspects of the invention as described elsewhere in the specification.

What is claimed is:

1. An image management system, comprising:
a management application accessible by a processor and adapted to monitor access to a plurality of image files; and
an interface adapted to chronologically display a plurality of thumbnail images corresponding to the access of the corresponding image files.

2. The system of claim 1, wherein each of the thumbnail images is linked to a corresponding image file.

3. The system of claim 1, further comprising an editor application accessible by the processor and adapted to modify each of the image files.

4. The system of claim 1, wherein the interface automatically updates the display of thumbnail images in response to the access one of the image files.

5. The system of claim 1, wherein the interface is adapted to horizontally display the thumbnail images.

6. The system of claim 1, wherein the interface is adapted to vertically display the thumbnail images.

7. The system of claim 1, wherein the interface is adapted to display a predetermined quantity of the thumbnail images.

8. The system of claim 1, wherein the access of the image file comprises printing the image file.

9. The system of claim 1, wherein the access of the image file comprises opening the image file.

10. The imaging system of claim 1, wherein the access of the image file comprises selecting one of the thumbnail images.

11. An image management method, comprising:
monitoring a plurality of requests each relating to an access of a corresponding image file; and
chronologically displaying on an interface a plurality of thumbnail images corresponding to the access of the image files.

12. The method of claim 11, wherein monitoring comprises monitoring a request selected from the group consisting of opening one of the image files, printing one of the image files, modifying one of the image files, and selecting one of the thumbnail images.

13. The method of claim 11, wherein chronologically displaying comprises displaying a predetermined quantity of the thumbnail images.

14. The method of claim 11, wherein chronologically displaying comprises vertically displaying the thumbnail images.

15. The method of claim 11, wherein chronologically displaying comprises horizontally displaying the thumbnail images.

16. The method of claim 11, further comprising automatically updating the display of thumbnail images in response to the access of one of the image files.

17. The method of claim 11, further comprising automatically generating the thumbnail images corresponding to the image files in response to the access.

18. An image management system, comprising:
means for monitoring access to a plurality of image files; and
means for chronologically displaying a plurality of thumbnail images corresponding to the access of the corresponding image files.

19. The system of claim 18, further comprising means for modifying at least one of the image files.

20. The system of claim 18, wherein the means for chronologically displaying comprises means for vertically displaying the thumbnail images.

21. The system of claim 18, wherein the means for chronologically displaying comprises means for horizontally displaying the thumbnail images.

22. The system of claim 18, wherein the means for monitoring comprises monitoring a request selected from the group consisting of receiving a selection of one of the thumbnail images, receiving a request to open one of the image files, receiving a request to print one of the image files, receiving a request to copy one of the image files, and receiving a request to attach one of the images files to an electronic mail message.

23. The system of claim 18, further comprising means for automatically updating the displayed thumbnail images in response to the access of one of the image files.

24. The system of claim 18, further comprising means for receiving a predetermined quantity of thumbnail images to display.

25. The system of claim 18, further comprising means for controlling a quantity of thumbnail images displayed.

26. An image management system, comprising:
a database accessible by a processor and having a plurality of image files; and
a management application accessible by a processor and adapted to automatically generate a plurality of thumbnail images corresponding to each of the image files in response to an access of each of the corresponding image files.

27. The system of claim 26, further comprising an interface adapted to display the thumbnail images.

28. The system of claim 27, wherein the interface is adapted to chronologically display the thumbnail images corresponding to the access.

29. The system of claim 27, wherein the interface is adapted to concurrently display the thumbnail images.

30. The system of claim 27, wherein the interface is adapted to relocate a display position of at least one of the thumbnail images in response to the access of one of the image files.

31. The system of claim 26, wherein the access of one of the image files is selected from the group consisting of a selection of one of the thumbnail images, a request to copy one of the image files, a request to print one of the image files, and a request to open one of the image files.

32. The system of claim 26, further comprising an editor application accessible by the processor and adapted to modify at least one of the image files.

33. The system of claim 26 wherein the management application is adapted to determine whether a quantity of displayed thumbnail images exceeds a predetermined quantity.

34. The system of claim 26, further comprising an interface adapted to automatically update a display of thumbnail images in response to the access of one of the image files.

35. The system of claim 26, wherein the management application is adapted to determine whether a thumbnail image has been previously generated corresponding to one of the accessed image files.
